(19) United States
(12) Patent Application Publication
(10) Pub. No.: US 2015/0278101 A1
(43) Pub. Date: Oct. 1, 2015

(54) ACCESSING DATA

(71) Applicant: EMC Corporation, Hopkinton, MA (US)

(72) Inventors: Yingchao Zhou, Beijing (CN); Haiyun Bao, Beijing (CN); Weigang (Oliver) Zhong, Beijing (CN)

(21) Appl. No.: 14/672,913

(22) Filed: Mar. 30, 2015

(30) Foreign Application Priority Data
Mar. 31, 2014 (CN) 201410135722.8

(51) Int. Cl. G06F 12/08

(52) U.S. Cl. CPC G06F 12/0868; G06F 12/0811; G06F 2212/604; G06F 2212/283

(57) ABSTRACT

Embodiments of the present disclosure relate to a method and apparatus for accessing data by receiving a data read request for reading data corresponding to a logical block number; determining a first physical block corresponding to the first logical block number on the disk when a first cache page corresponding to the first logical block number does not exist in a cache; and reading data in the second cache when a second cache corresponding to the second physical block exists in the cache, wherein the content of the second physical block is identical to the content of the first physical block. Some embodiments of the present disclosure may prevent storing mass redundant data, and thereby enhance data reading rate.

### RELATED APPLICATION

This application claims priority from Chinese Patent Application Number CN201410135722.8 filed on Mar. 31, 2014 entitled “METHOD AND APPARATUS FOR ACCESS DATA” the content and teachings of which is herein incorporated by reference in its entirety.

### FIELD OF THE INVENTION

Embodiments of the present disclosure generally relate to the field of data access.

### BACKGROUND OF THE INVENTION

Virtualization means building a virtual platform between computer hardware and an operating system on the computer hardware through a software or hardware method, so as to virtualize a plurality of independent virtual hardware running environment for the operating system and share hardware resources. For example, a server virtualization allows a plurality of virtual machines having heterogeneous operating systems to run in parallel in mutual isolation on the same computer hardware, wherein each virtual machine has its own virtual hardware set (e.g., a read-only memory, a central processor, etc.) and loads the operating system and application program on the virtual machine.

Generally, a virtual machine is encapsulated in a file, such that the virtual machine can be likely quickly saved, duplicated, and provided. For example, a virtual machine fully configured with an application, an operating system, BIOS, and virtual hardware may be moved from one physical server to a further physical server in dozens of seconds, thereby used for zero downtime maintenance.

Although virtualization has many advantages, virtualization might cause unnecessary storage of mass redundant data in a processor, register, cache, and read-only memory and the like. For example, in order to operate the 16 (or more) server applications in a virtual server environment into 16 virtual machines, they must be respectively loaded in the memory, even though they have the same data, file, executable file, etc.

In order to illustrate how to organize a cache in a storage system, FIG. 1 shows an exemplary data structure on a disk and a data structure in a cache. As shown in exemplary FIG. 1, the data structures beneath the dotted line is the data structures of file 1 and file 2 on the disk, while the data structures above the dotted line is the data structures of file 1 and file 2 in the cache. In order to simplify the description, the cache page size in the cache is supposed to be equal to the physical block size on the disk, which is indeed so in may practical products, although not necessary.

As illustrated in a typical example in FIG. 1, file 1 comprises a plurality of logical block numbers (LBN), which are LBN n, LBN n+1, LBN m and LBN m+1. Beneath the dotted line, these logic block numbers are pointed to one physical block in a plurality of physical blocks through a direct pointer (and indirect pointer), respectively, i.e., physical block a, physical block b, physical block c, and physical block d; meanwhile, the plurality of physical blocks correspond to one cache page in a plurality of cache pages, respectively, i.e., cache page a, cache page b, cache page c, and cache page d. Therefore, plurality of LBNs in file 1 corresponds to the plurality of cache pages as a one-to-one mapping. Similarly, file 2 may also include a plurality of logical block numbers (LBN), which are LBN N, LBN N+1, LBN M, and LBN M+1; they are pointed to one physical blocks in a plurality of physical blocks through a direct pointer (and indirect pointer), respectively, namely, physical block A, physical block B, physical block C, and physical block D, respectively; and the plurality of physical blocks also correspond to one cache page in a plurality of cache pages, i.e., cache page A, cache page B, cache page C, and cache page D. Therefore, a plurality of LBNs in the file D2 corresponds to the plurality of cache pages in a one-to-one mapping.

By indexing with the logical block number in the file (i.e., offset in the file) through the manner illustrated in FIG. 1, upon receiving a read/write request, the memory system can quickly locate the cache page without a need of any other operation based on the offset in the read/write request. Usually, the index is implemented by some kinds of hash mechanisms. For example, in the Linux kernel 2.6, the indexing is implemented through a radix tree. In the windows kernel, the indexing is implemented through a multi-stage index array.

However, in exemplary FIG. 1, if LBN n+1, LBN m+1, LBN N, and LBN M correspond to a plurality of physical blocks containing the same content and/or a plurality of cache pages containing the same content, respectively, the physical block (shadowed with oblique lines) of the same content on the disk will be repetitively stored for multiple times, and the cache page (shadowed with vertical lines) of the same content in the cache will also be repetitively stored for multiple times, thereby causing unnecessary storage of mass redundant data.

Those skilled in the art would appreciate that the illustration in FIG. 1 as discussed above may not be limited to the embodiments of operation in a virtual machine environment described above. On the contrary, provision of this is only meant for illustrating an illustrative technical field in which some embodiments described here may be implemented.

### SUMMARY OF THE INVENTION

To this end, embodiments of the present disclosure provide a method and apparatus for accessing data.

The method and apparatus for accessing data according to the embodiments of the present disclosure may avoid storing mass redundant data, thereby enhancing data access rate.

### BRIEF DESCRIPTION OF THE ACCOMPANYING DRAWINGS

Through detailed description below with reference to the accompanying drawings, the above and other objectives, features, and advantages of the embodiments of the present disclosure will become easily comprehensible. In the accompanying drawings, several embodiments of the present disclosure are illustrated in an exemplary, rather than limitative, manner, wherein:

FIG. 1 illustrates an exemplary data structure on a disk and a data structure in a cache according to relevant technology;

FIG. 2 illustrates an exemplary data structure on a disk and a data structure in a cache according to the embodiments of the present disclosure;

FIG. 3 illustrates an exemplary flow diagram of a method for accessing data according to the embodiments of the present disclosure; and

FIG. 4 illustrates an exemplary structural block diagram of an apparatus for accessing data according to the embodiments of the present disclosure.

It should be noted that the flow diagrams and block diagrams in the accompanying drawings illustrate a possibly implemented hierarchical architecture, function and operation of an apparatus, method, and computer program product according to various embodiments of the present disclosure. At this point, each block in the flow diagram or block diagram may represent a part of a module, program section, or code, which part contains one or more executable instructions for implementing prescribed logical functions. It should also be noted that in some implementations as replacements, the functions annotated in the blocks may also occur in a sequence different from what are annotated in the drawings. For example, two successively represented blocks may be executed in substantially parallel in reality, or even executed in a reverse order, depending on the functions as involved. It should also be noted that each block in the block diagrams and/or flow diagrams, as well as a combination of blocks in the block diagrams and/or flow diagrams, may be implemented by a dedicated hardware-based system for performing prescribed functions or operations, or implemented using a combination of dedicated hardware and computer instructions.

### DETAILED DESCRIPTION

Hereinafter, the principle and spirit of the present disclosure will be described with reference to several exemplary embodiments as shown in the drawings. It should be understood that provision of these embodiments is only for enabling those skilled in the art to better understand and then further implement the embodiments of the present disclosure, rather than limiting the scope of the embodiments of the present disclosure in any manner.

According to one embodiment, there is provided a method for accessing data, comprising: receiving a data read request for reading data corresponding to a logical block number; determining a first physical block corresponding to the first logical block number on the disk when a first cache page corresponding to the first logical block number does not exist in a cache; and reading data in the second cache when a second cache corresponding to the second physical block exists in the cache, wherein the content of the second physical block is identical to the content of the first physical block.

A further embodiment comprises: reading data in the second physical block when the second cache page corresponding to the second physical block does not exist in the cache.

A further embodiment comprises: creating a third cache page for storing the data in the cache after reading data in the second physical block, and corresponding the first logical block number to the third cache page.

A further embodiment, when a second cache page corresponding to the second physical block exists in the cache, corresponding the first logical block number to the second cache page.

A further embodiment comprises: pointing a pointer on the disk that originally pointing to the first physical block to the second physical block.

A further embodiment comprises: corresponding the second physical block to the second cache page through a physical block number in the cache.

A further embodiment comprises: receiving a data write request for writing to-be-written data into a cache page corresponding to a second logical block number; when a fourth cache page corresponding to the second logical block number exists in the cache, creating, in the cache, a fifth cache page different from the fourth cache page and for writing the to-be-written data, wherein the fourth cache page corresponds to the third physical block in the disk, and a fourth physical block having identical content to the third physical block exists in the disk; and corresponding the second logical block number to the fifth cache page, and writing the to-be-written data into the fifth cache page.

A further embodiment comprises the to-be-written data and the data in the fourth cache page are written together into the fifth cache page.

A further embodiment comprises: when the cache does not have a cache page corresponding to the second logical block number, creating, in the cache, a sixth cache page for writing the to-be-written data; and corresponding the second logical block number to the sixth cache page, and writing the to-be-written data into the sixth cache page.

In one embodiment, the to-be-written data and data in the fifth physical block in the disk are written together into the sixth cache page.

A further embodiment comprises: writing data in the created cache page into the disk periodically or when the number of created cache pages reaches a predetermined threshold.

A further embodiment comprises: pointing a pointer on the disk that originally pointing to the fourth physical block to the third physical block.

A further embodiment comprises: corresponding the third physical block to the fourth cache page through a physical block number in the cache.

According a further embodiment of the present disclosure, there is provided an apparatus for accessing data, comprising: a first receiving module configured to receive a data read request for reading data corresponding to a logical block number; a first determining module configured to determine a first physical block corresponding to the first logical block number on the disk when a first cache page corresponding to the first logical block number does not exist in a cache; and a first reading module configured to read data in a second cache when the second cache corresponding to the second physical block exists in the cache, wherein the content of the second physical block is identical to the content of the first physical block.

A further embodiment comprises: a second reading module configured to read data in the second physical block when the second cache page corresponding to the second physical block does not exist in the cache.

A further embodiment comprises: a first creating module configured to create a third cache page for storing the data in the cache after reading data in the second physical block, and a first corresponding module configured to correspond the first logical block number to the third cache page.

In one embodiment, when a second cache page corresponding to the second physical block exists in the cache, corresponding the first logical block number to the second cache page.

A further embodiment comprises: a first pointing module configured to point a pointer on the disk that originally pointing to the first physical block to the second physical block.

A further embodiment comprises: a second corresponding module configured to correspond the second physical block to the second cache page through a physical block number in the cache.

A further embodiment comprises: a second receiving module configured to receive a data write request for writing to-be-written data into a cache page corresponding to a second logical block number; a second creating module configured to, when a fourth cache page corresponding to the second logical block number exists in the cache, creating, in the cache, a fifth cache page different from the fourth cache page and for writing the to-be-written data, wherein the fourth cache page corresponds to the third physical block in the disk, and a fourth physical block having identical content to the third physical block exists in the disk; and a first writing module configured to correspond the second logical block number to the fifth cache page, and write the to-be-written data into the fifth cache page.

In one embodiment, the first wringing module configured to write the to-be-written data and the data in the fourth cache page together into the fifth cache page.

A further embodiment comprises: a third creating module configured to, when the cache does not have a cache page corresponding to the second logical block number, creating, in the cache, a sixth cache page for writing the to-be-written data; and a second writing module configured to correspond the second logical block number to the sixth cache page, and write the to-be-written data into the sixth cache page.

In one embodiment, the second writing module is configured to write the to-be-written data and data in the fifth physical block in the disk are together into the sixth cache page.

A further embodiment comprises: a third writing module configured to write data in the created cache page into the disk periodically or when the number of created cache pages reaches a predetermined threshold.

A further embodiment comprises: a second pointing module configured to point a pointer on the disk that originally pointing to the fourth physical block to the third physical block.

A further embodiment comprises: a fifth corresponding module configured to correspond the third physical block to the fourth cache page through a physical block number in the cache.

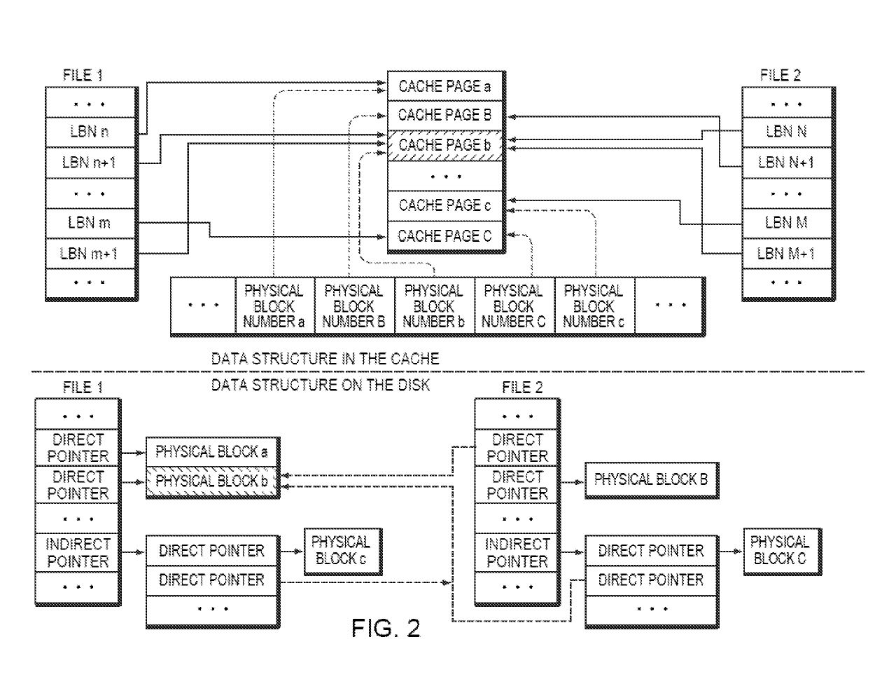

According to one embodiment of the present disclosure, there is provided a method for accessing data. The method may be implemented for example based on FIG. 2.

As illustrated in exemplary FIG. 2, file 1 comprises a plurality of logical block numbers (LBN), which are LBN n, LBN n+1, LBN m, and LBN m+1, respectively. They are pointed to one physical blocks in a plurality of physical blocks through a direct pointer (or an indirect pointer), respectively. However, because contents of LBN n+1 and LBN m+1 pointed to the physical blocks are identical, in order not to store mass redundant data, embodiments of the present disclosure point the pointer originally pointing to the physical block to which the LBN m+1 was pointed to the physical block to which LBN n+1 is pointed, i.e., physical block b. Those skilled in the art will understand that the pointer of the physical block originally pointing to the physical block to which the LBN n+1 was pointed and the pointer originally pointing to the physical block to which the LBN m+1 was pointed to other physical blocks. Meanwhile, the plurality of physical blocks also corresponds to one cache page in a plurality of cache pages, i.e., cache a, cache b, and cache c. Therefore, each LBN in a plurality of LBNs in file 1 can correspond to one cache page in the plurality of cache pages.

Similarly, file 2 also includes a plurality of logical block numbers (LBN), which are LBN N, LBN N+1, LBN M, and LBN M+1, respectively; they are pointed to one physical block in a plurality of physical blocks through a direct pointer (or indirect pointer), respectively. However, because the contents of the physical blocks corresponding to LBN N and LBN N+1 are identical, in order not to store mass redundant data, the embodiments of the present disclosure point the pointer originally pointing to the physical block to which the LBN N was pointed and the pointer originally pointing to the physical block to which the LBN M+1 was pointed to the physical block to which the LBN n+1 is pointed, i.e., physical block b. Meanwhile, the plurality of physical blocks also correspond to one cache page in a plurality of cache pages, respectively, i.e., cache page b, cache page B, and cache page C. Therefore, each LBN in a plurality of LBNs in the file 2 can correspond to one cache page in the plurality of cache pages.

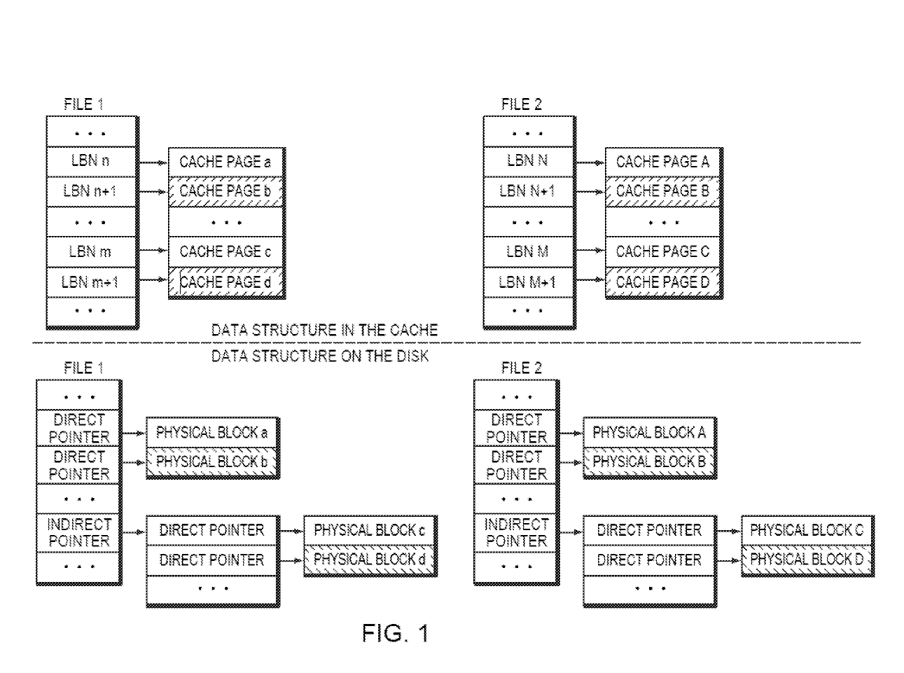

It is seen that FIG. 2 differs from FIG. 1 mainly in that all pointers on a disk originally pointing to physical blocks with identical content point to the same physical block, and the same cache page is similarly employed in the cache, which cache may correspond to the physical block through a physical block number in the cache.

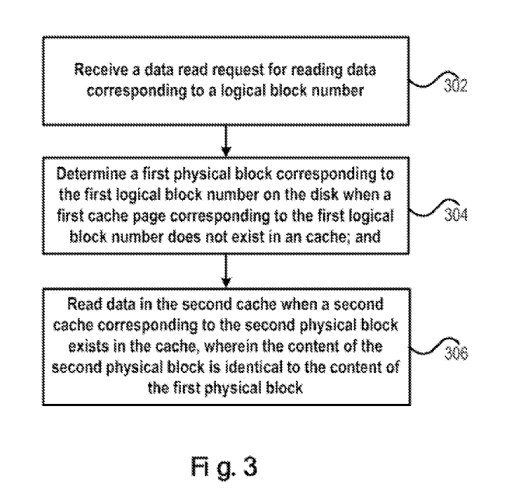

FIG. 3 illustrates an exemplary flow diagram of a method for accessing data according to the embodiments of the present disclosure.

Step S302: receive a data read request for reading data corresponding to a logical block number;

Step S304, determine a first physical block corresponding to the first logical block number on the disk when a first cache page corresponding to the first logical block number does not exist in a cache; and

Step S306, read data in the second cache when a second cache corresponding to the second physical block exists in the cache, wherein the content of the second physical block is identical to the content of the first physical block.

In this embodiment, for a first physical block and a second physical block with identical content on the disk, the same cache page (e.g., cache page b) is adopted in a cache, thereby avoiding storage of mass redundant data in the cache. Meanwhile, data are read from a second cache page (the second cache page may be pre-created in the cache), rather than reading data from the first physical block or the second physical block, which may enhance the data read rate. Test shows that by adopting this embodiment, for a virtual machine environment having 16 virtual machines, its actual storage space is only 90.82% of the original storage space, while for a virtual machine environment having 128 virtual machines, its actual storage space is only 88.65% of the original storage space.

Specifically, step S304 may be performed through the following manner. In this manner, a per-file indexing system is queried to look up whether the first cache exists, wherein the per-file indexing system stores correspondence relationships between respective logical block numbers and the cache pages. If the first cache page exists, data in the first cache page are read and duplicated to an output buffer, and subsequently a next logical block number in the data read request is obtained and is subjected to the same processing method. If the first cache page does not exist, a first physical block corresponding to the first logical block number will be determined on the disk, wherein the first physical block may be queried through a direct pointer (or indirect pointer) on the disk.

Besides, step S306 may be performed in the following manner. A deduplication indexing system is queried to look up whether the second cache page exists, wherein the deduplication indexing system stores correspondence relationships between respective physical blocks having identical contents and the cache pages. Hereinafter, a specific operation whether the second cache page exists will be illustrated with reference to specific embodiments.

In one embodiment of the present disclosure, when the second cache page exists, data in the second cache page may be read and duplicated to the output buffer, and then a next logical block number in the data read request is obtained and subjected to the same processing method. Further, after reading data in the second cache page, the first logical block number may correspond to the second cache page. In this way, if the data corresponding to the first logical block number needs to be read again later, the data in the second cache page may be directly read, without a need of determining a corresponding physical block in the disk, thereby enhancing the data read rate.

In one embodiment of the present disclosure, when the second cache page does not exist, data in the second physical block having identical content as the first physical block may be read, and the data are duplicated into the output buffer; and then a next logical block number in the data read request is obtained and is subjected to the same processing method. Then, after the data in the second physical block are read, a third cache page for storing the data may be created in the cache, and the first logical block number is made to correspond to the third cache page. In this way, if there is a need to read data again corresponding to the first logical block number, the data in the third cache page may be directly read, without a need of determining a corresponding physical block in the disk, thereby enhancing the data reading rate.

In order to correspond the first logical block number to the second cache page or to the third cache page, embodiments of the present disclosure may update the per-file indexing system and the deduplication indexing system.

In one embodiment of the present disclosure, a pointer on a disk originally pointing to the first physical block points to the second physical block. Therefore, for the first physical logical block and the second physical block having identical contents on the disk, a same physical block (e.g., physical block b) is adopted on the disk to store data, thereby avoiding storage of mass redundant data on the disk.

According to one embodiment of the present disclosure, a redundancy engine may be utilized to perform deduplication to a plurality of physical blocks in a disk using a deduplication engine. For example, when the deduplication engine finds the first physical block and the second physical block with identical contents in the disk, the first physical block may be deleted, and the pointer on the disk that originally pointing to the first physical block is made to point to the second physical block. During this process, the cache page originally corresponding to the first physical bock may also be invalidated, thereby saving the cache space.

In one embodiment of the present disclosure, the second physical block corresponds to the second cache page through a physical block number in the cache. For example, as illustrated in FIG. 2, the physical block b corresponds to the cache page b through a physical block number b in the cache, such that the corresponding cache page may be quickly located through the physical block number b in the cache.

In the embodiments shown in step S302 to step S306 for a plurality of physical blocks having the same contents and corresponding to a plurality of logical block numbers, respectively, the same physical block (e.g., physical block b) is employed on the disk to store data so as to avoid storage of mass redundant data on the disk, and the same cache page is employed in the cache to store data so as to store mass redundant data. However, one problem of this embodiment lies in that when there is a need to write into a physical block and/or cache page corresponding to a logical block number therein, the writing in all probability will affect other data in the physical block and/or cache page where there is no need to write. To this end, the method for accessing data according to the embodiments of the present disclosure may also comprise steps S402 to S406 infra.

Step S402, receive a data write request for writing to-be-written data into a cache page corresponding to a second logical block number.

Step S404, when a fourth cache page corresponding to the second logical block number exists in the cache, create a fifth cache page different from the fourth cache page and for writing to-be-written data in the cache, wherein the fourth cache corresponds to a third physical block in the disk, and a fourth physical block having contents identical to the third physical block exists in the disk.

Step S406, correspond the second logical block number to the fifth cache page, and write the to-be-written data into the fifth cache page.

Embodiments as shown in step S402—step S406 may solve the above problem, because the fourth cache corresponding to the second logical block number is not utilized to write the to-be-written data; instead, a new fifth cache page is created to write the to-be-written data, thereby preventing the writing from affecting other data in the physical block and/or cache page which do not have a need for the write.

It should be noted that all writing operations in the embodiments of the present disclosure will take an example of first writing the cache page and then writing the physical block. Those skilled in the art would appreciate that direct writing into a physical block (also called non-cache writing) may bypass the cache system through invalidating a corresponding cache page. Although direct writing into a physical block is not frequently used, it should also be incorporated into the scope of protection of the present disclosure.

Specifically, step S404 and step S406 may be performed through the following manner. In this manner, the per-file indexing system is queried to search whether the fourth cache page exists, wherein the per-file indexing system stores correspondence relationships between respective logical block numbers and the cache pages. Hereinafter, specific operations when the fourth cache page exists or not will be illustrated with reference to specific embodiments.

When the fourth cache page exists, the embodiments of the present disclosure may create a new fifth cache page, and the to-be-written data may be written into the fifth cache page from an input buffer, wherein the fourth cache page corresponds to the third physical block in the disk, and a fourth physical block having the same content as the third physical block exists in the disk. Here, if the write operation is a partial block write, the embodiments of the present disclosure may also duplicate partial data into the fifth cache page from the fourth cache page, so as to form the data in the fifth cache page with the to-be-written data.

Then, the embodiments of the present disclosure may also update the per-file indexing system so as to point out that it is the fifth cache page that corresponds to the second logical block number. In this case, if the data corresponding to the second logical block number need to read again later, the data in the fifth cache page may be directly read, without a need of determining a corresponding physical block in the disk, thereby enhancing the data read rate. Those skilled in the art would appreciate that the fourth cache page will not be affected, and can still be found through a deduplication index.

Subsequently, the embodiments may also obtain a next logical block number in the data write request and employ the same processing method.

If the cache does not have any cache page corresponding to the second logical block number, embodiments of the present disclosure may also create a new sixth cache page and write the to-be-written data into the sixth cache page from the input buffer, wherein duplicating partial data from the fifth physical block in the disk may be performed through the manner described above as disclosed in step S306, thereby duplicating partial data from a cache page corresponding to the fifth physical block in the cache.

Subsequently embodiments of the present disclosure may also update the per-file indexing system to indicate that it is the sixth cache page that corresponds to the second logical block number. In this way, if data corresponding to the second logical block number need to be read again, the data in the sixth cache page may be directly read, without a need of determining a corresponding physical block in the disk, thereby enhancing the data read rate.

Subsequently embodiments may also obtain the next logical block number in the data write request and employ the same processing method.

According to one embodiment of the present disclosure, each time after creating a new cache page, the cache page may also be flagged, e.g., flagging the cache page to be dirty. Subsequently a flushing mechanism may be triggered periodically, or as per each accessed file, and/or when the number of dirty cache pages reaches a predetermined threshold, wherein the flushing mechanism may correspondingly store the data in the flagged cache page into the disk.

Specifically, during the flushing period, the per-file indexing system is queried to search for a physical block corresponding to the flagged cache page. Different flushing manners may be employed depending on whether the disk has other physical blocks having the same contents as the physical block.

If the disk has other physical blocks having the same content as the physical block, a new physical block will be assigned, wherein the new physical block is used for the data in the flagged cache page to be written into. Subsequently the deduplication indexing system is updated to correspond the new physical block to the flagged cache page.

If the disk does not have other physical blocks having the same content as the physical block, the data in the flagged cache page are written into the physical block, and the deduplication indexing system is updated to correspond the physical block to the flagged cache page.

In one embodiment of the present disclosure, the pointer on the disk that originally pointing to the fourth physical block points to the third physical block. Therefore, for the third physical block and the fourth physical block having the same content on the disk, the same physical block is employed on the disk to store data, thereby preventing mass redundant data on the disk.

According to one embodiment of the present disclosure, a plurality of physical blocks may be performed for deduplication using a deduplication engine in the disk. For example, when the deduplication engine finds, in the disk, a third physical block and a fourth physical block having the same contents, the fourth physical block may be deleted, and the pointer originally pointing to the fourth physical block is made to point to the third physical block. During this process, the cache page originally corresponding to the fourth physical block may be invalidated, thereby saving the cache space.

In one embodiment of the present disclosure, the third physical lock is made to correspond to the fourth cache page through a physical block number in the cache.

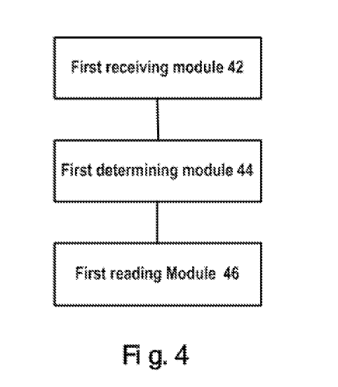

FIG. 4 shows a structural block diagram of an apparatus for accessing data according to the embodiments of the present disclosure. As shown in FIG. 4, there comprises a first receiving module 42, a first determining module 44, and a first reading module 46. Hereinafter, its structure will be described in detail.

First receiving module 42 is configured to receive a data read request for reading data corresponding to a logical block number; first determining module 44 connected to the receiving module 42 and configured to determine a first physical block corresponding to the first logical block number on the disk when a first cache page corresponding to the first logical block number does not exist in a cache; and first reading module 46 connected to the first determining module 44 and configured to read data in the second cache when a second cache corresponding to the second physical block exists in the cache, wherein the content of the second physical block is identical to the content of the first physical block.

In one embodiment, the apparatus further comprises: a second reading module configured to read data in the second physical block when the second cache page corresponding to the second physical block does not exist in the cache.

In one embodiment, the apparatus further comprises: a first creating module configured to create a third cache page for storing the data in the cache after reading data in the second physical block, and a first corresponding module configured to correspond the first logical block number to the third cache page.

In one embodiment, when a second cache page corresponding to the second physical block exists in the cache, corresponding the first logical block number to the second cache page.

In one embodiment, the apparatus further comprises: a first pointing module configured to point a pointer on the disk originally pointing to the first physical block to the second physical block.

In one embodiment, the apparatus further comprises: a second corresponding module configured to correspond the second physical block to the second cache page through a physical block number in the cache.

In one embodiment, the apparatus further comprises: a second receiving module configured to receive a data write request for writing to-be-written data into a cache page corresponding to a second logical block number; a second creating module configured to, when a fourth cache page corresponding to the second logical block number exists in the cache, creating, in the cache, a fifth cache page different from the fourth cache page and for writing the to-be-written data, wherein the fourth cache page corresponds to the third physical block in the disk, and a fourth physical block having identical content to the third physical block exists in the disk; and a first writing module configured to correspond the second logical block number to the fifth cache page, and write the to-be-written data into the fifth cache page.

In one embodiment, the first wringing module is configured to write the to-be-written data and the data in the fourth cache page together into the fifth cache page.

In one embodiment, the apparatus further comprises: a third creating module configured to, when the cache does not have a cache page corresponding to the second logical block number, creating, in the cache, a sixth cache page for writing the to-be-written data; and a second writing module configured to correspond the second logical block number to the sixth cache page, and write the to-be-written data into the sixth cache page.

In one embodiment, the second writing module is configured to write the to-be-written data and data in the fifth physical block in the disk are together into the sixth cache page.

In one embodiment, the apparatus further comprises: a third writing module configured to write data in the created cache page into the disk periodically or when the number of created cache pages reaches a predetermined threshold.

In one embodiment, the apparatus further comprises: a second pointing module configured to point a pointer on the disk originally pointing to the fourth physical block to the third physical block.

In one embodiment, the apparatus further comprises: a fifth corresponding module configured to correspond the third physical block to the fourth cache page through a physical block number in the cache.

In view of the above, according to the embodiments of the present disclosure each of the modules above can be combined into a single caching module, wherein the caching module can be configured to collectively perform the tasks of each of the single module in an ordered manner to accomplish the data accessing and may prevent storing mass redundant data, and thereby enhance data reading rate. There is also provided a method and apparatus for accessing data according to an embodiment of the present disclosure.

The method comprises: receiving a data read request for reading data corresponding to a logical block number; determining a first physical block corresponding to the first logical block number on the disk when a first cache page corresponding to the first logical block number does not exist in a cache; and reading data in the second cache when a second cache corresponding to the second physical block exists in the cache, wherein the content of the second physical block is identical to the content of the first physical block. The method and apparatus for accessing data according to the embodiments of the present disclosure may prevent storing mass redundant data, and thereby enhance data reading rate.

Although the present disclosure has been described with reference to several preferred embodiments, it should be appreciated that the present disclosure is not strictly limited to the disclosed specific embodiments. The present disclosure intends to cover various amendments and equivalent arrangements included within the spirit and scope of the appended claims. The scope of the appended claims satisfies the broadest scope, thereby covering all such amendments, and equivalent structures and functions.

What is claimed is:

1. A method for accessing data, comprising:
receiving a data read request for reading data corresponding to a first logical block number;
determining a first physical block corresponding to the first logical block number on a disk when a first cache page corresponding to the first logical block number does not exist in a cache; and
reading data in a second cache when the second cache corresponding to a second physical block exists in the cache, wherein the content of the second physical block is identical to the content of the first physical block.

2. The method according to claim 1, further comprising:
reading data in the second physical block when the second cache page corresponding to the second physical block does not exist in the cache.

3. The method according to claim 2, further comprising:
creating a third cache page for storing the data in the cache after reading data in the second physical block, and the first logical block number corresponds to the third cache page.

4. The method according to claim 1, wherein the first logical block number corresponds to the second cache page when the second cache page corresponding to the second physical block exists in the cache.

5. The method according claim 4, further comprising:
directing a pointer on the disk originally pointing to the first physical block to the second physical block.

6. The method according claim 4, further comprising:
linking the second physical block to the second cache page through a physical block number in the cache.

7. The method according to claim 1, further comprising:
receiving a data write request for writing to-be-written data into a cache page corresponding to a second logical block number;
creating, in the cache, a fifth cache page different from the fourth cache page and for writing the to-be-written data, when a fourth cache page corresponding to the second logical block number exists in the cache, and wherein the fourth cache page corresponds to the third physical block in the disk, and a fourth physical block having identical content to the third physical block exists in the disk; and
linking the second logical block number to the fifth cache page, and writing the to-be-written data into the fifth cache page.

8. The method according to claim 7, wherein the to-be-written data and the data in the fourth cache page are written simultaneously into the fifth cache page.

9. The method according to claim 7, further comprising:
creating, in the cache, a sixth cache page for writing the to-be-written data, when the cache does not have a cache page corresponding to the second logical block number; and
linking the second logical block number to the sixth cache page, and writing the to-be-written data into the sixth cache page.

10. The method according to claim 9, wherein the to-be-written data and data in the fifth physical block in the disk are written simultaneously into the sixth cache page.

11. The method according to claim 10, further comprising:
writing data in the created cache page into the disk periodically or when the number of created cache pages reaches a predetermined threshold.

12. The method according to claim 10, further comprising:
directing a pointer on the disk originally pointing to the fourth physical block to the third physical block.

13. The method according claim 10, further comprising:
linking the third physical block to the fourth cache page through a physical block number in the cache.

14. An apparatus for accessing data, comprising:
a caching module configured to
receive a data read request for reading data corresponding to a logical block number;
determine a first physical block corresponding to the first logical block number on the disk when a first cache page corresponding to the first logical block number does not exist in a cache; and
read data in the second cache when a second cache corresponding to the second physical block exists in the cache, wherein the content of the second physical block is identical to the content of the first physical block.

15. The apparatus according to claim 14, further configured to read data in the second physical block when the second cache page corresponding to the second physical block does not exist in the cache.

16. The apparatus according to claim 15, further configured to create a third cache page for storing the data in the cache after reading data in the second physical block; and
link the first logical block number to the third cache page.

17. The apparatus according to claim 14, wherein when a second cache page corresponding to the second physical block exists in the cache, the first logical block number is made to correspond to the second cache page.

18. The apparatus according claim 17, further configured to direct a pointer on the disk originally pointing to the first physical block to the second physical block.

19. The apparatus according claim 17, further configured to link the second physical block to the second cache page through a physical block number in the cache.

20. A computer program product for facilitating management of resources, the computer program product comprising:
a non-transitory computer readable medium encoded with computer-executable code, the code configured to enable the execution of:
receiving a data read request for reading data corresponding to a first logical block number;
determining a first physical block corresponding to the first logical block number on a disk when a first cache page corresponding to the first logical block number does not exist in a cache; and
reading data in a second cache when the second cache corresponding to a second physical block exists in the cache, wherein the content of the second physical block is identical to the content of the first physical block.
